(19) United States
(12) Patent Application Publication
(10) Pub. No.: US 2009/0204689 A1
(43) Pub. Date: Aug. 13, 2009

(54) METHOD AND APPARATUS FOR REMOTE SURVEILLANCE OF A PREMISES

(76) Inventors: Cyrus Chipman, Wilmington, NC (US); Shucavage David, Wilmington, NC (US)

Correspondence Address: Thomas L. Peterson, Suite 703, 1233 20th Street, Washington, DC, 20036, US

(21) Appl. No.: 12/364,425

(22) Filed: Feb. 2, 2009

Related U.S. Application Data
(60) Provisional application No. 61/006,779, filed on Jan. 31, 2008.

(51) Int. Cl. G06F 15/16

(52) U.S. Cl. 709/219

(57) ABSTRACT

A method and apparatus for remote surveillance of a premises using graphic image captures of the premises under surveillance is disclosed. An intermediary web server is used to bridge the connection between a computer-camera and, e.g, a cell phone or other computer device so that images of the premises under surveillance can be viewed remotely. The computer, camera and server arrangement eliminates many of the configuration and network security problems associated with existing surveillance systems. The system of the invention records individual pictures at a rapid rate, rather than “movies.” This allows the application software or program which implements the system to run in the background on a client PC while other application programs are also running on the PC.

### CROSS REFERENCE TO RELATED APPLICATION

This application claims the benefit of Provisional U.S. Patent Application No. 61/006,779 filed Jan. 31, 2008 and entitled “Method and Apparatus for Remote Surveillance of a Premises”, which is incorporated by reference herein in its entirety.

### TECHNICAL FIELD

The present invention is generally directed to the field of surveillance and more particularly, is directed to a method and apparatus for remote surveillance of a premises using graphic image captures of the premises under surveillance in accordance with a novel scheme and method. The method and apparatus of the invention may also be used to monitor sounds within the premises, as well as other characteristics such as temperature, the presence of smoke, dangerous gases, door and window breaches and the like.

### BACKGROUND OF THE INVENTION

The one of the competitive advantage of the present invention is that it allows people to see what is going on in their home, office or business at any time in an inexpensive and easy to implement manner. The system leverages personal computers (PCs), fast internet connections, and web enabled cell phones that people already have, along with inexpensive USB cameras (or slightly more expensive IP/Network cameras) that are known in the art.

One of the keys to the present invention is the use of an intermediary server to bridge the connection between a computer-camera and, e.g, a cell phone or other computer device so that images of the premises under surveillance can be viewed remotely. The computer, camera and server arrangement of the present invention eliminates many of the configuration and network security problems associated with existing surveillance systems. Another important advantage of the present invention is that the system records individual pictures at a rapid rate, rather than “movies.” This allows the application software or program which implements the system of the invention to run in the background on a client PC while other application programs (word processing, web cruising etc.) are also running on the PC.

Communications between Client-Sever-Browser is a mix of both TCP/IP and HTTP protocols that are known in the art. In accordance with the present invention, the best protocols are used where necessary. Such use of protocols allows for efficient server operation, thus increasing the number of client PCs that the server can host.

The system of the present invention can be used to transmit not only pictures, but other information as well such as temperatures, window and door sensors data, etc.

The novel features of the present invention are set out with particularity in the following detailed description of the preferred embodiment. But the invention will be understood more fully and clearly from the detailed description of the invention as set forth in the accompanying drawings in which:

### BRIEF DESCRIPTION OF THE DRAWINGS

FIG. 1 illustrates an overall system view in accordance with a preferred embodiment of the present invention;

FIGS. 2-9 are block diagrams which illustrate various operating processes in accordance with a preferred embodiment of the present invention;

FIG. 10 illustrates an alternative system view in accordance with another embodiment of the present invention; and

FIG. 11 illustrates the present invention being used with a mobile device.

### DETAILED DESCRIPTION OF THE PREFERRED EMBODIMENT

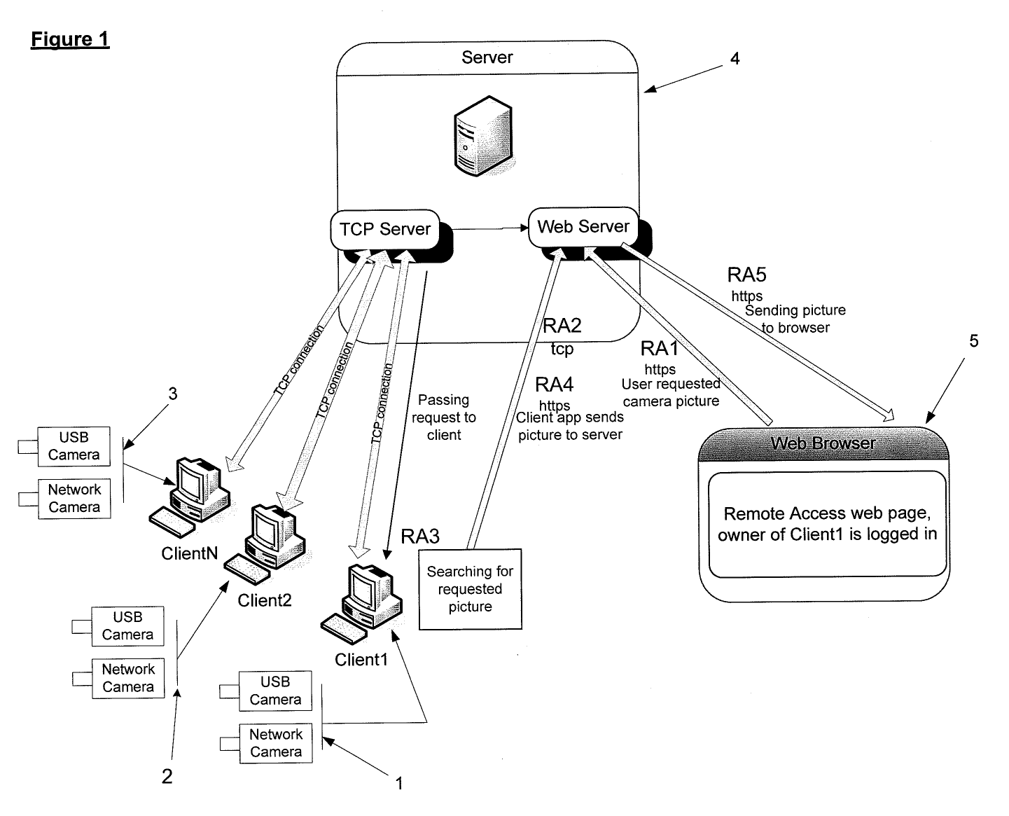

FIG. 1 illustrates an overview of a preferred embodiment of a remote surveillance system in accordance with the present invention. One or more conventional Client Computers Client1 through ClientN are each connected to one or more respective Cameras 1-3. Cameras 1-3 can be conventional USB cameras, conventional IP/Network cameras, or any simultaneous combination thereof. Client Computers Client1-Client3 continually log pictures from these cameras for later retrieval.

The Client Computers maintain a continuous communication with Server 4. Server 4 can also make a connection with one or more Web Browsers 5. A Browser 5 can request information contained on one or more specific Client Computers through Server 4. Upon receiving such a request from a Browser 5, Server 4 then requests the information from the specific Client Computer and sends it to the Browser 5 that requested it.

This communication process is initiated by the Client Computer which sends the initial message to Server 4. Server 4 then responds to the Client Computer, using the address in the Client Computer's original message. This means that the Client Computer can have any Network ID (identification) and that the Network ID can change over time. Server 4 is constantly updated with the Client Computer's location. This allows for both minimal setup and improved security. This methodology eliminates the problems normally encountered such as router configurations, fixed IP addresses, and network security protocols as known in the art.

As illustrated in FIG. 1, the communication throughout the system is done by both TCP/IP and HTTP protocols. The protocol used for a given task is chosen to maximize the speed and efficiency of the system. By using both protocols, a more efficient system is realized.

The application software that runs on Client Computers Client1-ClientN is designed to work in the background so that pictures can be taken and recorded without interfering with other task being performed on the client computer.

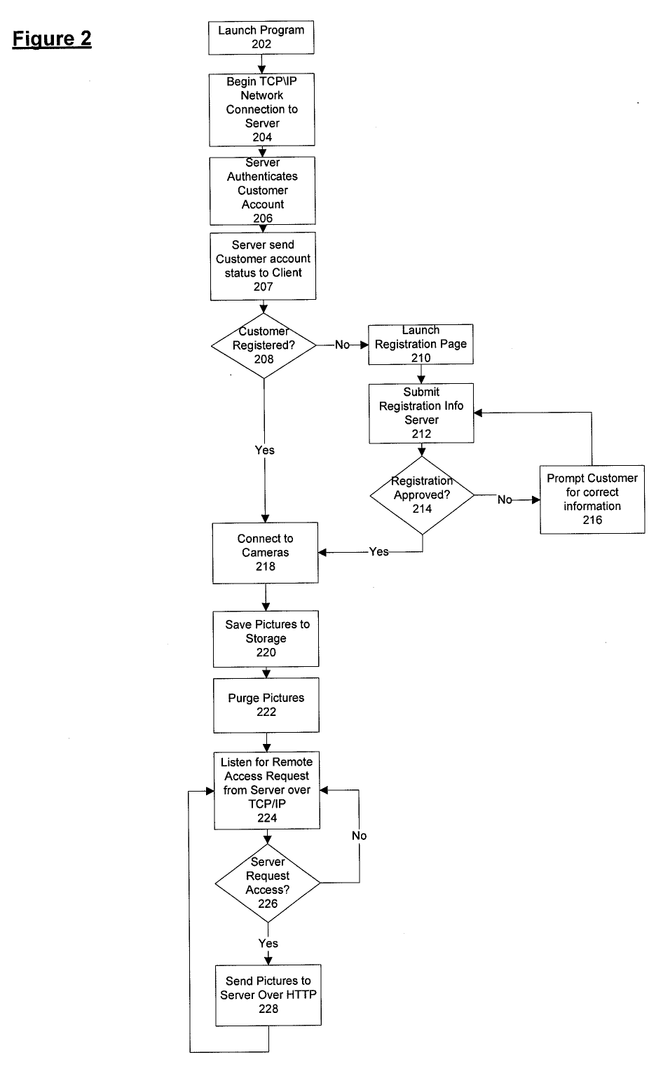

FIG. 2 is a block diagram illustrating how Client Computers Client1-ClientN communicate with Server 4 and stores and purges pictures.

A Client Computer program is launched in block 202 on a client computer such as a laptop, desktop PC, or an embedded system that has a connection to the internet. The client program establishes a connection to Server 4 using TCP/IP network protocol in block 204. The Server authenticates the user account continuously by verifying the users account status in a database, as known in the art, in block 206, and then sends a TCP/IP message with that status to the Client Computer in block 207. If the customer is registered, block 208, the Client Computer connects to the attached camera or cameras in block 218; if a USB camera is being used, the connection is made by a direct USB connection to the Client Computer, if a Network camera is used then the connection is made by TCP/IP protocol. The Client Computer program can make and maintain both types of connections simultaneously in any combination.

If this particular instance of the Client Computer program is not registered the Client launches a registration page to collect the registration information in block 210. The Client sends the registration information to the Server in block 212. If the registration is approved in block 214 then the Server notifies the Clint using TCP/IP protocol and the Client connects to the cameras in block 218. If the registration is not approved the Client prompts the user for correct information in block 216.

Once connected to the cameras in block 218, the Client begins storing pictures on any suitable data storage device such as a hard disk in block 220. This storage device can be on the computer the client is running on or the pictures can be stored on another computer. The pictures are stored individually in a single picture format such as a JPEG. The pictures can be stored continuously; the storage can begin only after the camera has detected motion, or both. By changing selector fields in the user interface the user can select the frequency at which pictures will be recorded.

Separate frequencies can be set for continuous recording or recording triggered by motion. A memory buffer between the camera and the hard drive is used to insure that no images are lost and that the images are written to the hard drive in an efficient manner. Time stamps are associated with the images as they enter this memory buffer to insure that the recorded time is accurate. Before the picture is saved a watermark is applied that insures the picture can not be tampered with out detecting that it has been changed. The user can select the time period that pictures will be stored, or the amount of storage space that will be devoted to picture storage. If time period is used, then pictures older than the prescribed time period will be automatically purged in block 222. If memory space is the criteria, the oldest pictures will be purged once the allotted space is reached in block 222. The purging routine is designed to minimize the load on the system resources by purging small numbers of pictures at a time, and by bypassing certain system algorithms, such as the “recycle bin” and delete verification routines commonly found on computer operating systems. This purging capability allows the system to run continuously without user input.

Alternatively the system of the present invention can archive the pictures to a different hard drive, a different storage medium like a CD, DVD, or flash drive, or internal or external network storage, before deleting them. The Client is in continuous contact with the Server using the TCP/IP protocol. When a request for a picture comes from the Server, the Client retrieves it from the stored pictures and sends the requested picture to the Server using HTTP in block 228. The Client then resumes waiting for the next request from the server for a picture in block 224.

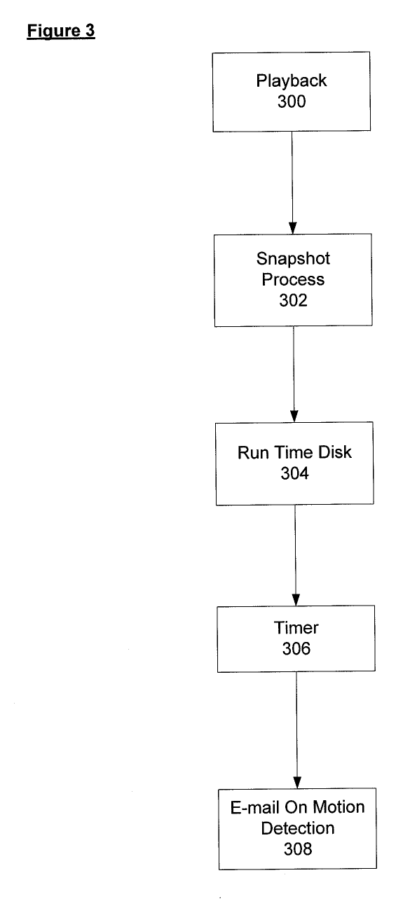

FIG. 3 is a block diagram illustrating other capabilities that the Client program can perform.

The Client can play back previously recorded pictures in block 300 in rapid succession allowing a person to view “video like” playback of what occurred and quickly scan a time period. The speed of the playback can be selected. The images can be viewed in both forward and reverse order. A graphical display allows the user to quickly pick the date and time playback is started. During playback the software can verify that the watermark of each frame is still valid. The playback can be automatically stopped at specified intervals, intervals can be repeated in a constant loop, or playback can be set to automatically stop at recording gaps, such as would exist if a capture period was triggered by a motion event. The user can also cycle through the individual pictures using the scroll control on a computer input such as a mouse or a touchpad.

The software allows “Snapshots” to be archived in block 302, storing individual frames of what the camera is viewing in real time, or from recorded pictures being viewed in the playback mode in block 300. The pictures can be automatically saved in a specified location and further automatically segmented in that location by time period. Individual cameras can have different locations. If one is storing pictures from the Playback mode then the software may be set to store sequential pictures by time period. The time the picture was taken can be displayed on the picture. The user can also annotate individual pictures with text they have entered in. The dates or text are displayed on the pictures but do not violate the watermark.

A “Run Time Disk” of a specified time period can be created by the Client software in block 304. A user specifies a time period to be saved, the software saves that time period to a removable media such as a CD or Flash Drive, or to another location, such as a networked hard drive. This media then contains not only the individual pictures taken during that time period but a player that allows them to be viewed using all the playback functionally described in block 300, including watermark verification. This allows a person to easily provide details of such an event to groups such as law enforcement.

The system includes an integrated timer in block 306 which allows the timer to be turned on or off, or the frequency of the recording changed, during specified intervals based on the date, time, or day of week. This allows the user to customize the system for the activities they want to record, or not record at all if it would be undesirable.

The system can automatically send an e-mail message to one or more e-mail addresses if motion is detected in block 308 as one of skill in the art would know how to do. The message can contain specified text, a picture of what is happening, and a Browser link to allow the user to quickly log onto the system directly to a view of the picture taken when the motion occurred. The user can then go forwards or backwards to view what happened before or after motion was triggered. Each individual camera can be set to send messages and images to different email addresses. The motion detection sensitivity can be set individually for each camera. The messages can also be triggered by other external triggers such as limit switches set to windows or doors, or temperature or moisture monitors. Alternatively, or simultaneously, the motion can trigger an external action such as causing an alarm to sound, lights to go on or a phone call to be made.

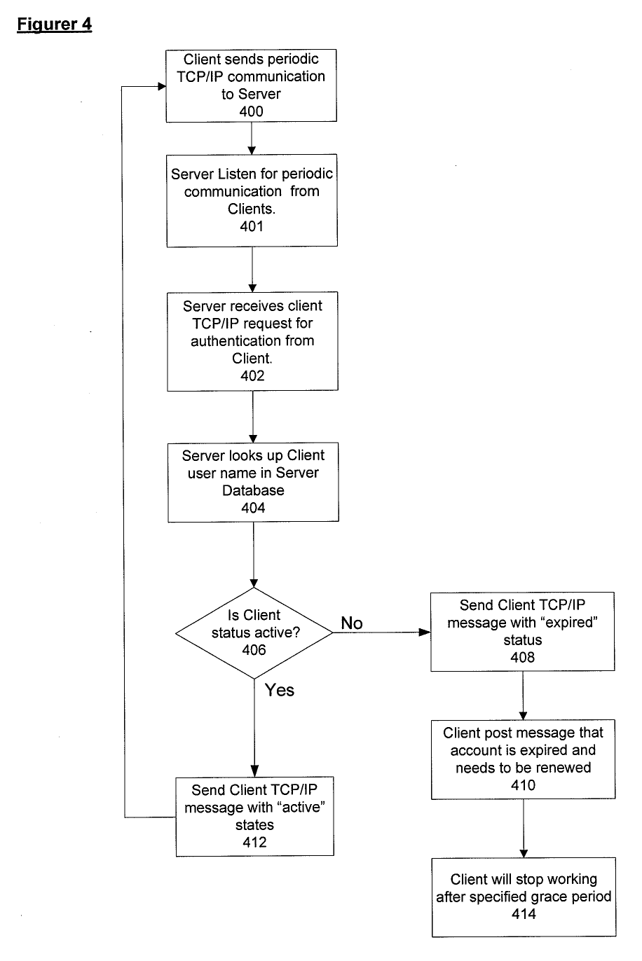

FIGS. 4-8 are block diagrams that illustrate various server processes and how the sever communicates with Client Computers and Browsers

FIG. 4—Server Authentication Processes: The Client sends periodic TCP/IP communications requests to the Server in block 400. The Server maintains a constant connection with Clients by listening for TCP/IP messages from all Clients in block 401. The Server receives the Client TCP/IP request in block 402. The Server looks up the Client name in the Server database in block 404. Based on the decision in block 406, if Client is listed in the database and its status is current, then the Server sends back a message to the Client confirming that the account status as “active” in block 412. After a given period of time the Client sends another message to the Server, repeating this process in block 412. Besides verifying that the Client account is active, this process also allows the Server to obtain the current IP address of the Client.

If the Client is not listed as active in the database, the Server returns a message that the status is “expired” in block 408. The Client then post a message that the account is expired and needs to be renewed in block 410. The Client will stop functioning after a specified grace period in block 414 until new or updated registration information is entered.

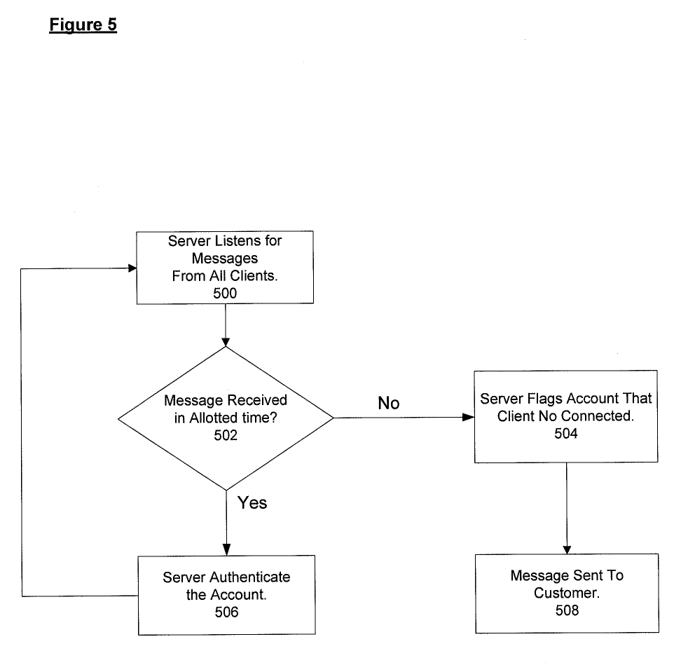

FIG. 5—Server Verification Process: In this process, the Server verifies that Client has maintained a constant connection to the Server. The server is constantly listening for the Client message in block 500. If the message is received in the allotted time in block 502, the Server authenticates the account and continues listening for the next message in block 506. If the message is not received in the allotted time, the Server flags the account that the Client is not connected in block 504. A message is then sent from the Server to the account owner that the Client is no longer connected in block 508. This message can be sent by e-mail, text message, phone call or other communication media. Thus, the customer is provided with verification that the connection to their camera or other sensors is functional.

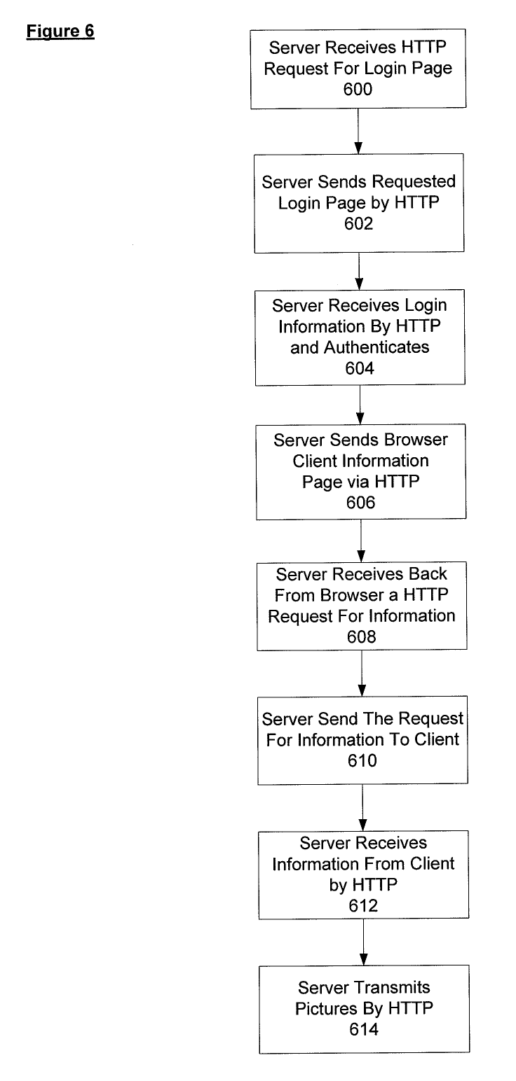

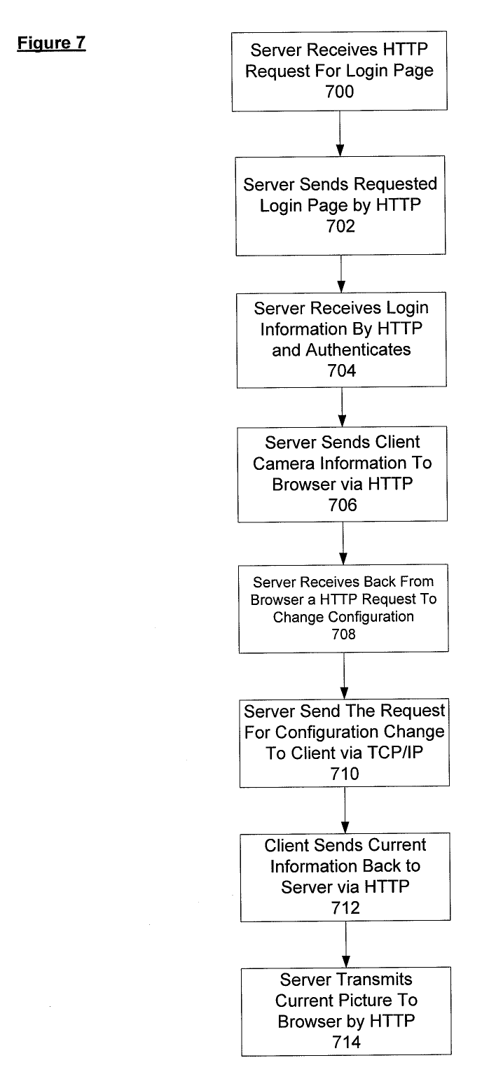

The Browser can be used to both request pictures and sensor data, from a Client, or to change the configuration of the Server or a specific Client. FIGS. 6 and 7 are block diagrams that describe each of these processes.

FIG. 6 illustrates how the Server manages communications with the Browser for pictures or other sensor data.

The Server receives a HTTP request from a Browser for a login page in block 600. The Server then sends a login page to the Browser by HTTP in block 602. The user inputs the login information and sends it back to the Server in block 604. The Server then sends the Client information page back to the Browser in block 606. This Client information page contains pictures and other sensor data as well as links to configuration options. The user then makes selections as to which information they wish to access and send this information back to the Server in block 608. The Server then requests this information from the Client in block 610. The Server receives the requested information back from the Client in block 612. The Server then transmits the information back to the Browser by HTTP in block 614.

FIG. 7 illustrates how the Browser can configure the Server and Client settings. The Server receives a HTTP request from a Browser for a login page in block 700. The Server then sends a login page to the Browser by HTTP in block 702. The user inputs the login information and sends it back to the Server in block 704. The Server then Sends the Client information page back to the Browser block 706. This Client information page contains pictures and other sensor data as well as links to configuration options. The user then makes selections as to which configurations on the Server and or the individual Client they wish to change in block 708. The Server then makes these changes to the Server configurations, or sends the configuration change to the individual Client via TCP/IP connection in block 710. The Client then sends updated information to the Server via HTTP in block 712. The Server then sends this information to the Browser by HTTP in block 714.

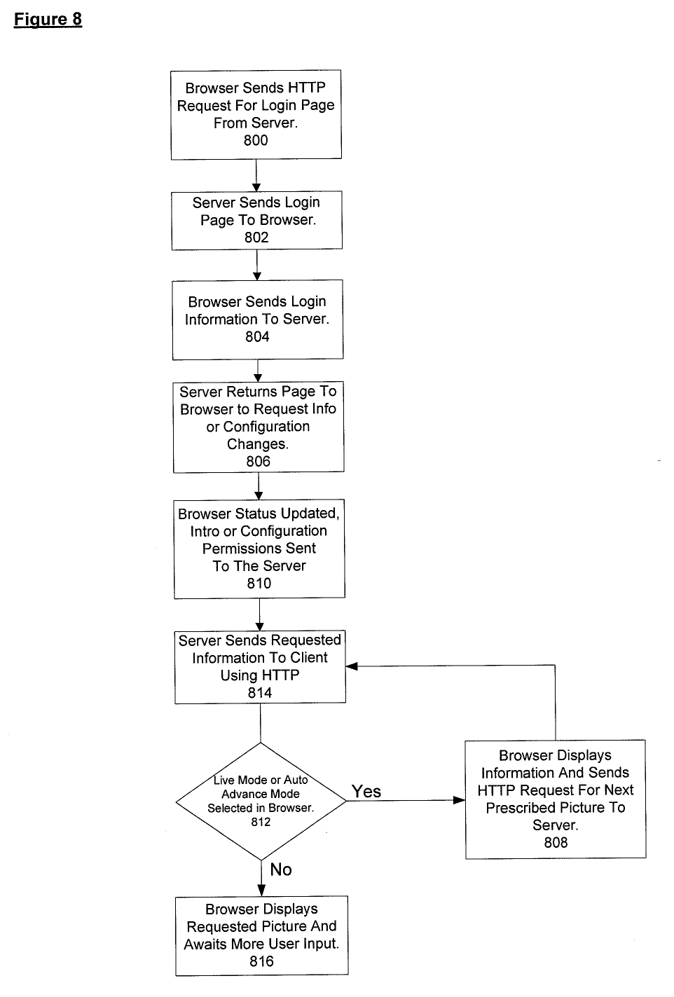

FIG. 8 is a block diagram as of the process as driven by the Browser. The Browser requests a login page from the Server in block 800. The Server then sends a login page to the Browser by HTTP in block 802. The user inputs the login information and sends it back to the Server in block 804. The Server then sends the Client information page back to the Browser in block 806. The Browser then sends a request for info to the Server in block 810. The Server returns the requested info to the Browser in block 814. If the Browser is set for either “live” mode or “auto advance” in block 812 then the Browser sends repeated HTTP request for the next set of info to the Server and the cycle repeats 808. If the Browser is not set for live or auto advance then the browser displays the picture and awaits more input.

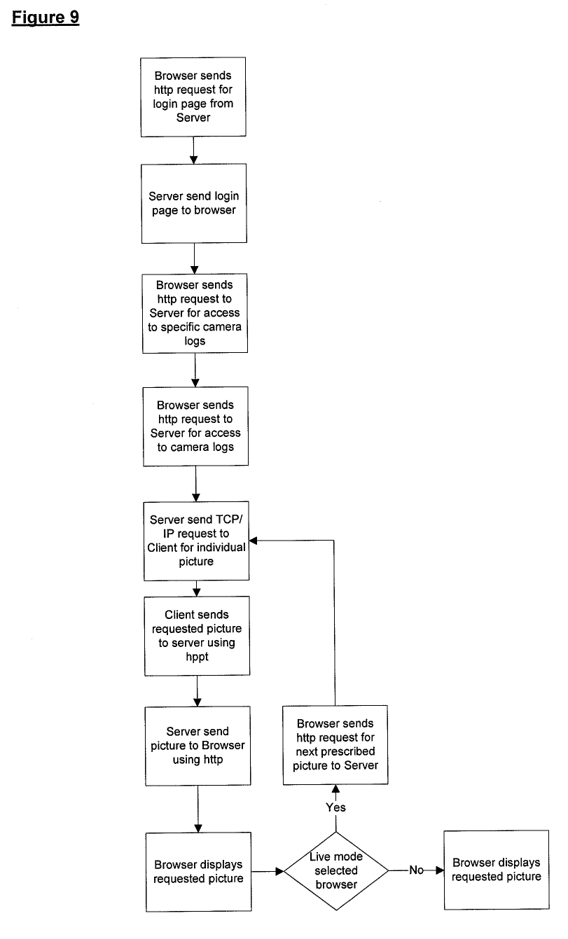

FIG. 9 is a further block diagram of an alternative process driven by the Browser. The process illustrated in this block diagram is similar to the process shown in FIG. 8.

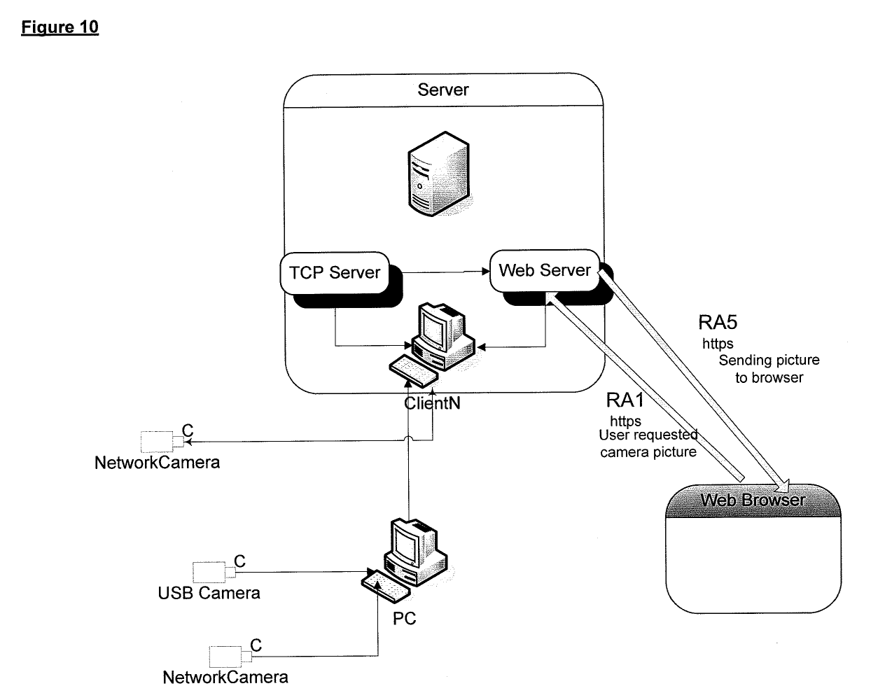

FIG. 10 illustrates a second embodiment of a remote surveillance system in accordance with the present invention. In this embodiment, information is stored away from the recording location. One way this can be done is to place all of the Client functions on a separate “embedded Client” that is part of or associated with the Server. IP/Network cameras can connect to this embedded Client directly. Alternatively a local Client can collect the information from USB and/or IP/Network Cameras and transmit this information to an embedded Client associated with the server, or just store the information at the Server.

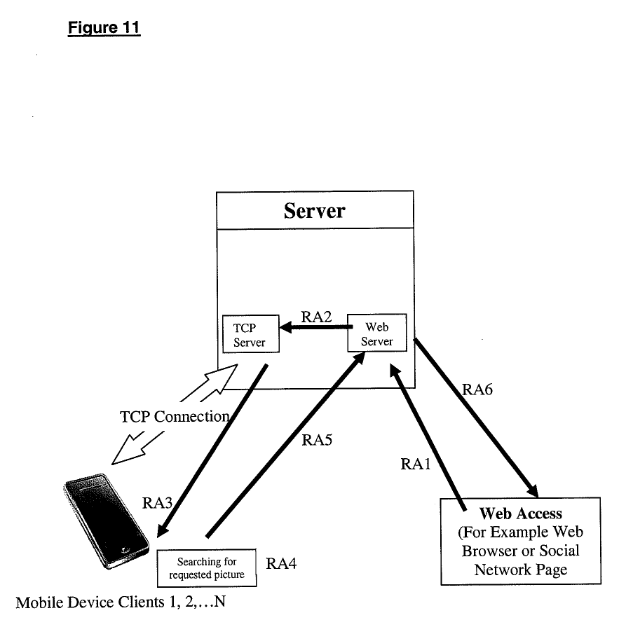

FIG. 11 illustrates the operation of the present invention when used with a mobile such as a smart phone. The operation of the invention with respect to a mobile device is essentially the same as explained above with respect to a Client Computer.

It should be obvious from the above-discussed embodiment of the present invention that numerous other variations and modifications of the invention are possible, and such will readily occur to those skilled in the art. Accordingly, the scope of this invention is not to be limited to the embodiment disclosed, but is to include any such embodiments as may be encompassed within the scope of the above described preferred embodiment.

We claim:

1. A system for remote surveillance of a premises, said system comprising:
a web server;
a first client computer coupled to said web server;
at least one camera coupled to said first client computer for taking at least one picture of the premises under surveillance;
first computer software running on said first client computer, said second computer software being adapted to control the operation of said camera and to transmit said picture to said web server; and
second computer software running on said web server and adapted to receive said picture from said first client computer and to transmit said picture to a second client computer coupled to said web server.
